(19) United States
(12) Patent Application Publication
(10) Pub. No.: US 2024/0281703 A1
(43) Pub. Date: Aug. 22, 2024

(54) Intelligent Machine Environment Layout Adjustment

(71) Applicant: International Business Machines Corporation, Armonk, NY (US)

(72) Inventors: Jeremy R. Fox, Georgetown, TX (US); Su Liu, Austin, TX (US); Tushar Agrawal, West Fargo, ND (US); Sarbajit K. Rakshit, Kolkata (IN); Michael Boone, Lutz, FL (US)

(21) Appl. No.: 18/172,466

(22) Filed: Feb. 22, 2023

(51) Int. Cl. G06N 20/00

(52) U.S. Cl. CPC G06N 20/00

(57) ABSTRACT

Managing machine layouts to improve machine activity workflows is provided. An analysis of a digital twin simulation of an environment is performed in accordance with a machine activity workflow corresponding to a plurality of machines located in the environment. A machine layout is generated for the environment that includes at least one of a particular set of machines having a determined amount of computational capability needed to analyze a type, volume, and frequency of data generated in each logical group of machines within the environment based on the analysis of the digital twin simulation. The machine layout is implemented automatically in the environment by positioning the at least one of the particular set of machines having the determined amount of computational capability needed to analyze the type, volume, and frequency of the data generated in each logical group of machines within the environment.

### BACKGROUND

The disclosure relates generally to machine environment layouts and more specifically to intelligently adjusting machine environment layouts to improve machine activity workflow efficiency and safety.

Machine environment layout is the way in which machines, workstations, materials storage, and the like are positioned in relation to each other within a machine environment. The machine environment may be, for example, a workshop, machine shop, industrial floor, manufacturing floor, production environment, agricultural environment, or the like. The machine environment may include any type of machine, such as, for example, lathes, drill presses, saws, conveyors, rollers, punch presses, hydraulic presses, grinders, iron working machines, milling machines, shaping machines, data processing devices, and the like.

### SUMMARY

According to one illustrative embodiment, a computer-implemented method for managing machine layouts to improve machine activity workflows is provided. A computer, using a machine learning model, performs an analysis of a digital twin simulation of an environment in accordance with a machine activity workflow corresponding to a plurality of machines located in the environment. The computer, using the machine learning model, generates a machine layout for the environment that includes at least one of a particular set of machines having a determined amount of computational capability needed to analyze a type, volume, and frequency of data generated in each logical group of machines within the environment based on the analysis of the digital twin simulation in accordance with the machine activity workflow corresponding to the plurality of machines. The computer implements the machine layout automatically in the environment by positioning the at least one of the particular set of machines having the determined amount of computational capability needed to analyze the type, volume, and frequency of the data generated in each logical group of machines within the environment using mobility systems corresponding to the plurality of machines. According to other illustrative embodiments, a computer system and computer program product for managing machine layouts to improve machine activity workflows are provided.

### BRIEF DESCRIPTION OF THE DRAWINGS

FIG. 1 is a pictorial representation of a computing environment in which illustrative embodiments may be implemented;

FIGS. 2A-2B are a diagram illustrating an example of a machine layout management system in accordance with an illustrative embodiment;

FIG. 3 is a diagram illustrating an example of a machine layout management process in accordance with an illustrative embodiment; and

FIGS. 4A-4C are a flowchart illustrating a process for managing machine layouts to improve machine activity workflows in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

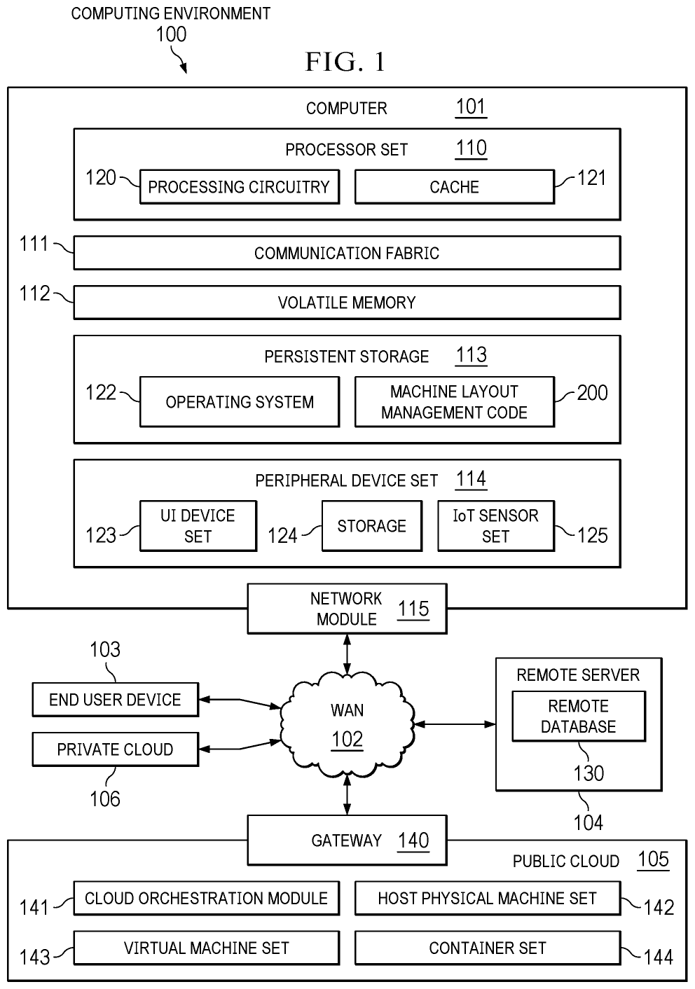

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as machine layout management code 200. Machine layout management code 200 intelligently adjusts machine environment layouts to improve machine activity workflow efficiency, effectiveness, and safety. For example, machine layout management code 200 intelligently and dynamically optimizes machine environment layouts, monitors machine activity workflows, and analyzes process sequences, along with performs digital twin simulations to identify contextual scenarios that may require different amounts and types of machine computational capabilities across a particular machine environment layout. Machine layout management code 200 also utilizes the digital twin simulations to identify accident and safety scenarios to ensure that machine computational capabilities can address accident and safety issues corresponding to the machines in the environment and provide feedback to the machine manufacturers to consider future machine capabilities as new machines are manufactured.

Machine layout management code 200 performs an analysis of various arrangements of the machines within the machine environment and/or the activities performed by the machines to determine machine activity workflow improvements based on the analysis of the various arrangements. Machine layout management code 200 also determines, for example, the optimal machine layout within the environment, needed computational capability of certain machines within different areas of the environment, machine and human safety, machine activity order, machine activity adjustments for accident mitigation, machine software upgrades, machine hardware upgrades, machine maintenance scheduling to reduce downtime, and the like.

In addition to machine layout management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and machine layout management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in machine layout management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The machine layout management code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a customer of the machine layout management services provided by computer 101), and may take any of the forms discussed above in connection with computer 101. EUD 103 typically receives helpful and useful data from the operations of computer 101. For example, in a hypothetical case where computer 101 is designed to provide a machine environment layout recommendation to an end user, this machine environment layout recommendation would typically be communicated from network module 115 of computer 101 through WAN 102 to EUD 103. In this way, EUD 103 can display, or otherwise present, the machine environment layout recommendation to the end user. In some embodiments, EUD 103 may be a client device, such as thin client, heavy client, mainframe computer, desktop computer, laptop computer, tablet computer, smart watch, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a machine environment layout recommendation based on historical data, then this machine environment layout historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

A faulty machine layout in a machine environment can results in, for example, increased materials movement and handling between machines, increased machine activities during product manufacturing, increased movement of workers and mobile machines within the environment, and the like causing decreased efficiency. A faulty machine environment layout can also increase the amount of labor and equipment needed to move materials to machines within the environment, which can lead to delays at machines and make it difficult to find work in progress within the environment. Furthermore, space is wasted within the environment.

Improving the machine environment layout can decrease costs when, for example, the raw materials used are very large and heavy, such as rolls of sheet metal in a sheet metal working process, timber in a woodworking process, and the like. For example, in joinery (i.e., joining pieces of wood to produce a more complex product), cost savings from an improved machine environment layout can be increased because woodworking machines cut timber very quickly. As a result, if the woodworking machines are arranged in an ideal order within the environment, then delay between the woodworking machines to produce the final product is decreased or minimized during the entire manufacturing process. In a faulty machine environment layout, the time spent moving the large and heavy pieces of timber from materials storage to the machine floor and then around to the different machines, themselves, may be, for example, five or ten times longer than the timber cutting time.

In a typical machine environment, a multitude of different types of machines exists. In addition, some or all of the machines in the environment can have different computational capabilities so that these machines having computational capabilities can become self-sufficient by performing different computations and collaborating with each other as per the machine environment layout to improve machine activity workflow.

Typically, machines are arranged as per machine activity workflow with different machines performing different activities. These different machine activities and combinations of these different machine activities can have different complexities, safety issues, and the like. As a result, different machine computational capabilities are needed in different areas of the machine environment. Consequently, a new solution is needed to simulate these different machine activities in any machine environment as per machine layout to identify how the computational capabilities of machines should be placed in the different areas of the machine environment.

Illustrative embodiments take into account and consider machine layout, machine output, real time feeds from area sensors (e.g., IoT devices such as cameras, motion detectors, temperature detectors, and the like) located within and around the environment, real time feeds from machine sensors (e.g., counters, speed detectors, operational detectors, vibration detectors, temperature detectors, pressure detectors, and the like) located on the machines, themselves, machine activity workflow, and the like. Illustrative embodiments utilize the real time data feeds received from the area sensors and machine sensors to monitor operations of the machines in the environment that includes, for example, relationships between respective machines (e.g., machine activity workflow), relative physical position of each respective machine, activities performed by respective machines, and the like. Moreover, illustrative embodiments perform digital twin simulations to identify different types of contextual scenarios that can occur within different areas of the machine environment layout to determine where machine computational capabilities are needed.

Illustrative embodiments also determine the machine locational and computational needs of different machines for the machine activity workflow of the machine environment layout. Illustrative embodiments identify any relationships among the different machines within the environment, relative position of each machine within the environment, spacing between the machines based on the machine type, size, and activity, and the like. Illustrative embodiments automatically instruct machines having a mobility system or platform to move to different locations to meet the machine locational needs to improve the machine activity workflow of the machine environment layout. Illustrative embodiments predict computational needs of certain machines and send the predicted computational needs corresponding to those particular machines to the machine manufacturers so that the machine manufacturers can implement periodic hardware and software upgrades of those particular machines to provide the needed machine computational capabilities. However, it should be noted that illustrative embodiments can automatically perform an online search for machine software updates, fixes, and patches and automatically apply these updates, fixes, and patches to corresponding machines automatically to provide the needed machine computational capabilities. In addition, illustrative embodiments can also automatically generate a workorder for a machine upgrade and send the workorder to a mobile maintenance machine (e.g., bot) directing the mobile maintenance machine to add one or more physical devices (e.g., at least one of a processor, memory, storage, network interface card, or the like) to a particular machine to upgrade that particular machine with the needed machine computational capabilities.

Further, illustrative embodiments determine workload deployment based on machine computational capabilities. For example, illustrative embodiments estimate available computational capabilities of different machine layouts within the environment, and compare the estimated available computational capabilities with the computational needs associated with different machine activities. Based on the comparison, illustrative embodiments allocate different tasks of the machine activity workload to different areas of the machine environment layout. Illustrative embodiments can also distribute tasks corresponding to the machine activity workload to different machines based on the machine environment layout. It should be noted that each machine activity is comprised of a set of tasks.

Furthermore, illustrative embodiments select the appropriate machines for a particular layout and objective (e.g., produce a particular final product). For example, illustrative embodiments utilize a digital twin component of the computer to simulate machine activities to be performed by different machines using their respective capabilities in different contextual scenarios where machine computational capabilities are needed. Based on the different digital twin simulations, illustrative embodiments generate an optimal layout of machines by, for example, machine model, type, and activity for that particular environment.

Moreover, illustrative embodiments monitor different contextual scenarios generated by the digital twin component. For example, based on the digital twin simulations of the different contextual scenarios for a particular machine environment layout, illustrative embodiments also identify the type of data, volume of the data, and frequency of the data that machines with computational capabilities need to analyze in different areas of the machine environment. Based on the type, volume, and frequency of the data to be analyzed, illustrative embodiments determine which particular machines within different areas of the environment need to be upgraded to a new level of computational capability so that these particular machines can provide the needed computations for themselves and other machines within their respective areas of the environment (e.g., different logical groups of machines within the environment).

In addition, illustrative embodiments utilize the digital twin component to simulate potential accident scenarios in a particular machine environment layout. For example, the digital twin component simulates different accident scenarios for when machine safety guidelines are not followed in different areas of the machine environment layout. Based on the different simulated accident scenarios, illustrative embodiments generate a machine environment layout that provides machine computational capabilities for accident mitigation in given areas. In other words, illustrative embodiments can generate a machine layout for accident mitigation and needed machine computational capabilities by simulating different accident scenarios based on machine safety guidelines in different areas of the environment using the digital twin component of the computer.

Below is an illustrative example of how illustrative embodiments generate an optimal machine layout for a particular environment. Illustrative embodiments first identify and retrieve a machine activity workflow for a particular product. In other words, illustrative embodiments identify what activities are performed by different machines to produce, for example, the final product from raw materials. The machine activity workflow may be, for example, predefined and stored in a workflow database, which stores a plurality of different machine activity workflows for a plurality of different products.

Next, illustrative embodiments identify the relative physical position of each respective machine corresponding to the machine activity workflow in the machine environment based on the identified activity of each respective machine. Then, illustrative embodiments utilize the digital twin component of the computer to perform a digital twin simulation to identify how each respective machine in the environment is performing its corresponding activity as per the machine activity workflow. Illustrative embodiments also utilize digital twin simulations for different contextual scenarios, such as accident (e.g., worker injury), machine damage, product damage, material handling problem, adverse event (e.g., fire), safety issue, and the like. Illustrative embodiments base the different contextual scenarios on, for example, collected historical data from various machine environments. Illustrative embodiments utilize the digital twin simulations to identify what types of contextual scenarios are likely to occur in the machine environment and the likelihood of accidents occurring in each type of contextual scenario. Based on the digital twin simulations, illustrative embodiments can also identify the criticality of a particular contextual scenario that is likely to occur in the machine environment.

In addition, the digital twin component includes a machine learning model for determining how different contextual scenarios can be mitigated with proactive machine computation. Further, the digital twin component utilizes the machine learning model to determine what types of data, volume of the data, and frequency of the data that will be generated by certain machines in the environment. Furthermore, the digital twin component utilizes the machine learning model to determine the amount of computational capability needed by those certain machines within particular areas of the machine environment to analyze the generated data based on the type, volume, and frequency of the generated data by those machines. Moreover, the digital twin component utilizes the machine learning model to map the physical machine locations within the environment based on the determined amount of machine computational capability that should be present in given areas (e.g., each logical group of machines) of the machine environment.

Illustrative embodiments also analyze the availability of machines and their corresponding specification information, which includes, for example, machine size, activity performed, computational capability, maintenance schedule, and the like. Illustrative embodiments identify the type of activity and the volume of the activity that is to be performed by a particular machine based on its corresponding specification information. Illustrative embodiments take into account the various contextual scenarios, and accordingly determined the appropriate physical locations for the machines according to different machine layouts within the environment.

Based on the identified machine activity workflow and the determined appropriate machine locations, illustrative embodiments generate the optimum machine layout for the environment, which enables intelligent machine activity workflow. While illustrative embodiments assign different machine activities to different areas of the machine environment, illustrative embodiments also identify the machine computational capabilities needed in each of the different areas of the machine environment based on historical learning.

Illustrative embodiments allocate machine activities to different areas of the machine environment layout so that each particular machine activity can be performed effectively and efficiently. Further, illustrative embodiments utilize the digital twin component to run machine activity workflow simulations to identify possible different types and models of machines to perform the various machine activities more effectively and efficiently. Furthermore, illustrative embodiments can send a recommendation regarding the different types and models of machines that should be installed in the environment to the entity that operates the environment.

Moreover, illustrative embodiments can receive feedback from the entity that operates the environment regarding, for example, how much machine computational capabilities have been improved in given machines after those machines were upgraded, how much machine activity workflow has improved since using a new machine layout within the environment, and the like. For example, illustrative embodiments can receive positive machine layout feedback confirming positive computational utilization for machine placement within the environment. Conversely, illustrative embodiments can receive negative machine layout feedback indicating that the entity had to move machines one or more times due to lack of computational capabilities in certain areas of the environment. Illustrative embodiments can also receive ideal feedback indicating, for example, that no machine adjustment is needed after a machine software upgrade (i.e., the machine is now working properly or ideally). Illustrative embodiments can further receive usage feedback regarding iterative machine computational capability utilization over a period of time. Illustrative embodiments can also receive time-to-failure feedback indicating the estimated number of hours a particular machine can run until failure. Illustrative embodiments utilize this feedback information as training data for the machine learning model to increase predictive accuracy of machine learning model.

Illustrative embodiments can further utilize the digital twin simulation to identify functional capability and capacity of each available machine within an environment to prevent any potential disruptions in the event that one of the machines undergoes maintenance or fails. Illustrative embodiments can optimize production by delaying machine maintenance downtime when needed.

Thus, illustrative embodiments provide one or more technical solutions that overcome a technical problem with faulty or inefficient machine environment layouts. As a result, these one or more technical solutions provide a technical effect and practical application in the field of product manufacturing.

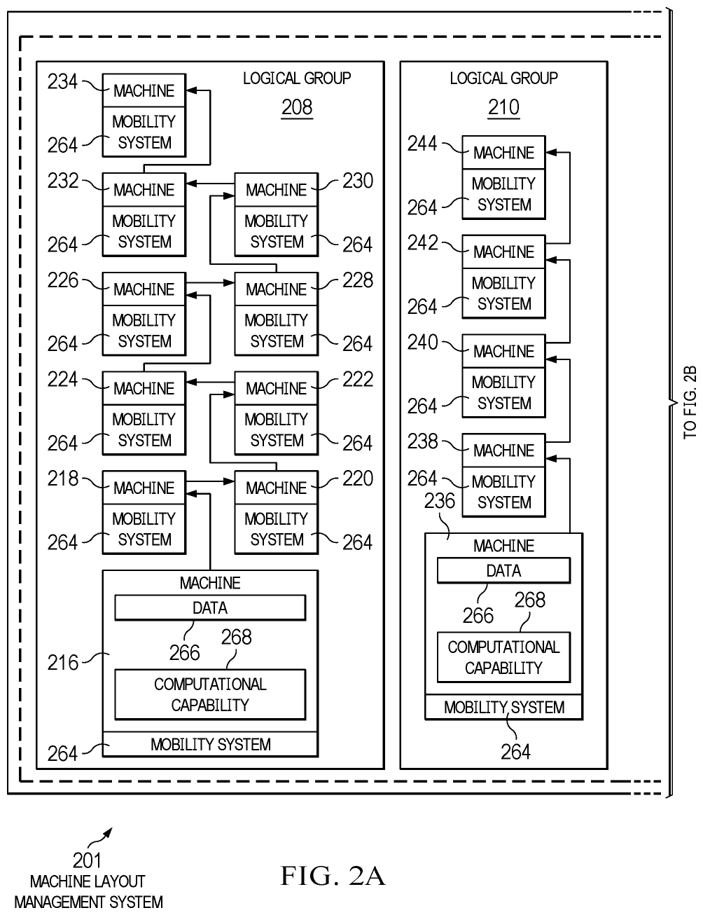

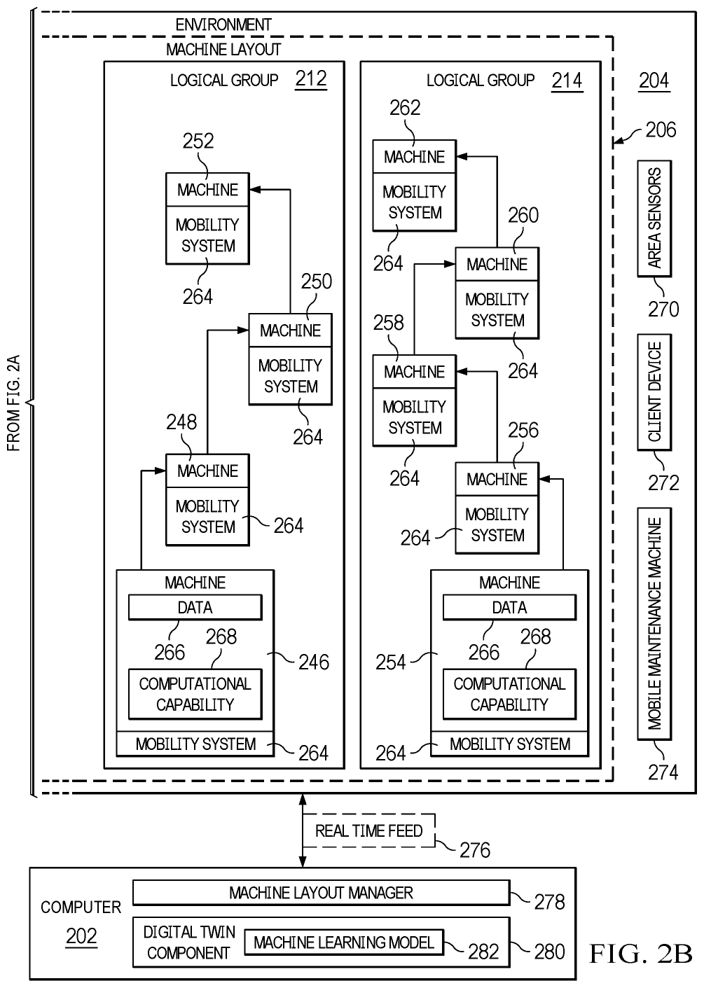

With reference now to FIGS. 2A-2B, a diagram illustrating an example of a machine layout management system is depicted in accordance with an illustrative embodiment. Machine layout management system 201 may be implemented in a computing environment, such as computing environment 100 in FIG. 1. Machine layout management system 201 is a system of hardware and software components for intelligently adjusting a machine environment layout to improve machine activity workflow efficiency and safety.

In this example, machine layout management system 201 includes computer 202 and environment 204. Computer 202 may be, for example, computer 101 in FIG. 1. Environment 204 represents any type of physical environment that includes a plurality of different physical machines performing a plurality of different activities to, for example, produce a physical object or item, such as a product. However, it should be noted that machine layout management system 201 is intended as an example only and not as a limitation on illustrative embodiments. For example, machine layout management system 201 can include any number of computers, environments, and other devices and components not shown.

In this example, environment 204 includes machine layout 206 for the plurality of different physical machines within environment 204. Machine layout 206 includes logical group 208, logical group 210, logical group 212, and logical group 214. A logical group of machines is a number of machines that are grouped logically to perform related machine activities. It should be noted that machine layout 206 is meant as an example only and can include any number of logical groups of machines in any type of machine layout or arrangement.

In this example, logical group 208 includes machine 216, machine 218, machine 220, machine 222, machine 224, machine 226, machine 228, machine 230, machine 232, and machine 234. Logical group 210 includes machine 236, machine 238, machine 240, machine 242, and machine 244. Logical group 212 includes machine 246, machine 248, machine 250, and machine 252. Logical group 214 includes machine 254, machine 256, machine 258, machine 260, and machine 262. The arrows between machines represent machine activity workflow between the machines for each logical group of machines. In addition, each machine includes mobility system 264. Mobility system 264 includes, for example, motorized wheels, rollers, treads, legs, or the like. Computer 202 can send control signals to mobility system 264 to move given machines to particular locations within environment 204 to improve machine activity workflow.

In this example, each of machine 216, machine 236, machine 246, and machine 254 generate data 266. Further, each of machine 216, machine 236, machine 246, and machine 254 computational capability 268. Data 266 represent any type of information related to the machine activity workflow for a given logical group of machines, such as logical group 208, logical group 210, logical group 212, or logical group 214. Machine 216, machine 236, machine 246, and machine 254 generate data 266 based on information received from at least one of a set of sensors located on one or more machines within each logical group of machines and area sensors 270. Area sensors 270 represent a plurality of sensors, such as, for example, video cameras, located throughout environment 204. Area sensors 270 monitor activity of, and interaction between, each of machines 216-262. Area sensors 270 can also collect information regarding machine layout 206, such as, for example, machine activity workflow between machines, machine spacing, and the like.

Machine 216, machine 236, machine 246, and machine 254 utilize computational capability 268 to analyze data 266. Computational capability 268 includes software components, such as, for example, programs, applications, scripts, and the like and hardware components, such as, for example, processor, memory, storage, network interface card, and the like. It should be noted that any machine in a given logical group of machines can generate data 266 and include computational capability 268 and that more than one machine in a given logical group of machines can generate data 266 and include computational capability 268.

Client device 272 corresponds to the entity that owns or operates environment 204. A user of client device 272 utilizes client device 272 to send a request to computer 202 to generate an optimal machine layout for environment 204.

Mobile maintenance machine 274 is, for example, a robotic machine capable of repairing and upgrading machines 216-262. For example, mobile maintenance machine 274 is capable of installing an upgraded processor, adding more memory or storage, and the like based on instructions received from computer 202.

Area sensors 270 send real time feed 276 containing the information regarding, for example, the activities, interactions, spacings, machine activity workflows of machines 216-262 to computer 202. Also, sensors located on any of machines 216-262 can send information to computer 202 via real time feed 276 as well.

Computer 202 utilizes machine layout manager 278 to analyze the information contained in real time feed 276. Machine layout manager 278 may be, for example, machine layout management code 200 in FIG. 1. Computer 202 utilizes digital twin component 280 to generate digital twin simulations of different configurations of machine layout 206 and different contextual scenarios or situations that can occur in environment 204. Digital twin component 280 includes machine learning model 282. Digital twin component 280 utilizes machine learning model 282 to predict the likelihood of different contextual scenarios and the probable impact of each contextual scenario on environment 204. Based on the results of the digital twin simulations and the analysis of real time feed 276, machine layout manager 278 generates an optimal machine layout for environment 204.

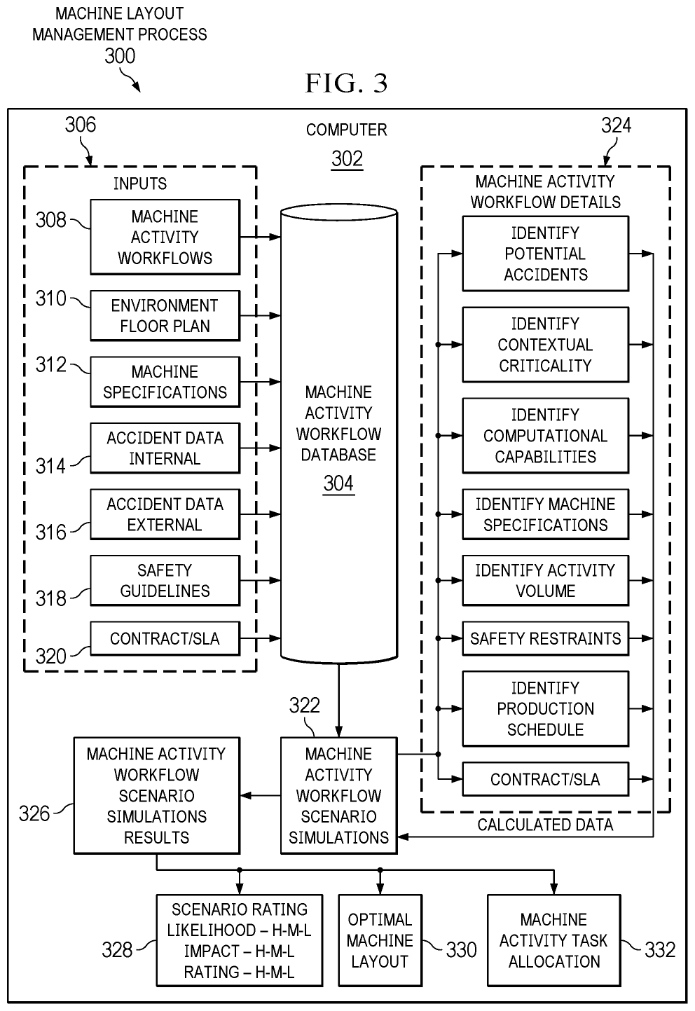

With reference now to FIG. 3, a diagram illustrating an example of a machine layout management process is depicted in accordance with an illustrative embodiment. Machine layout management process 300 is implemented in computer 302, such as, for example, computer 101 in FIG. 1 or computer 202 in FIG. 2B.

In this example, computer 302 includes machine activity workflow database 304. Computer 302 utilizes inputs 306 to generate machine activity workflow database 304. Inputs 306 include, for example, machine activity workflows 308, environment floorplan 310, machine specifications 312, accident data internal 314, accident data external 316, safety guidelines 318, and contract/service level agreement (SLA) 320.

Machine activity workflows 308 represent predefined workflows between machines in an environment, such as, for example, environment 204 in FIGS. 2A-2B, to produce different products. A machine activity workflow is movement of a product task output from one machine as input to another machine in a group of machines to produce a final product. Environment floorplan 310 represents a diagram of the design of the environment to scale. Machine specifications 312 represent a description of the details corresponding to each particular machine in the environment (e.g., input, activity performed, output, volume, maintenance schedule, computational capability, and the like). Accident data internal 314 represents historical information regarding accidents that have occurred within the environment previously. Accident data external 316 represents historical information regarding accidents that have occurred previously within same or similar environments. Safety guidelines 318 represent a set of standards or regulations regarding worker and machine safety within the environment. Contract/SLA 320 represents a contractual agreement between the customer and the entity that owns or operates the environment to produce the product for the customer.

Computer 302 utilizes a digital twin component, such as, for example, digital twin component 280 in FIG. 2B, to generate machine activity workflow scenario simulations 322 utilizing machine activity workflow details 324, which are identified from information contained in machine activity workflow database 304. In this example, machine activity workflow details 324 include potential accidents, contextual criticality, computational capabilities, machine specifications, activity volume, safety restraints, production schedule, and contract/SLA. Based on machine activity workflow scenario simulations 322, the digital twin component generates machine activity workflow scenario simulations results 326.

The digital twin component utilizes a machine learning model, such as, for example, machine learning model 282 in FIG. 2B, to generate scenario rating 328 for each respective scenario based on machine activity workflow scenario simulations results 326. Scenario rating 328 includes likelihood, impact, and rating of a particular scenario. For example, a scenario can have a high, medium, or low likelihood, a high, medium, or low impact, and a high, medium, or low rating.

The computer utilizes a machine layout manager, such as, for example, machine layout manager 278 in FIG. 2B, to generate optimal machine layout 330 for the environment based on, for example, a particular scenario having a low likelihood of occurrence in the environment, a low impact on the environment, and a high rating. Optimal machine layout 330 represents an ideal or best arrangement of machines within the environment to produce the product for the customer in the most efficient, effective, and safest manner possible. Further, the machine layout manager performs machine activity task allocation 332 between the machines according to optimal machine layout 330.

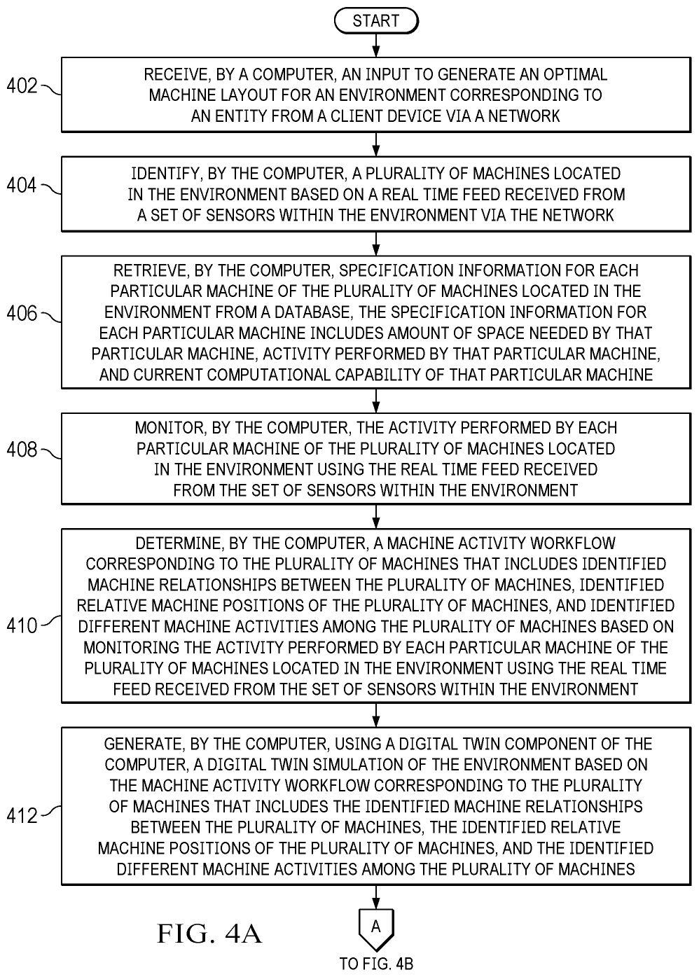

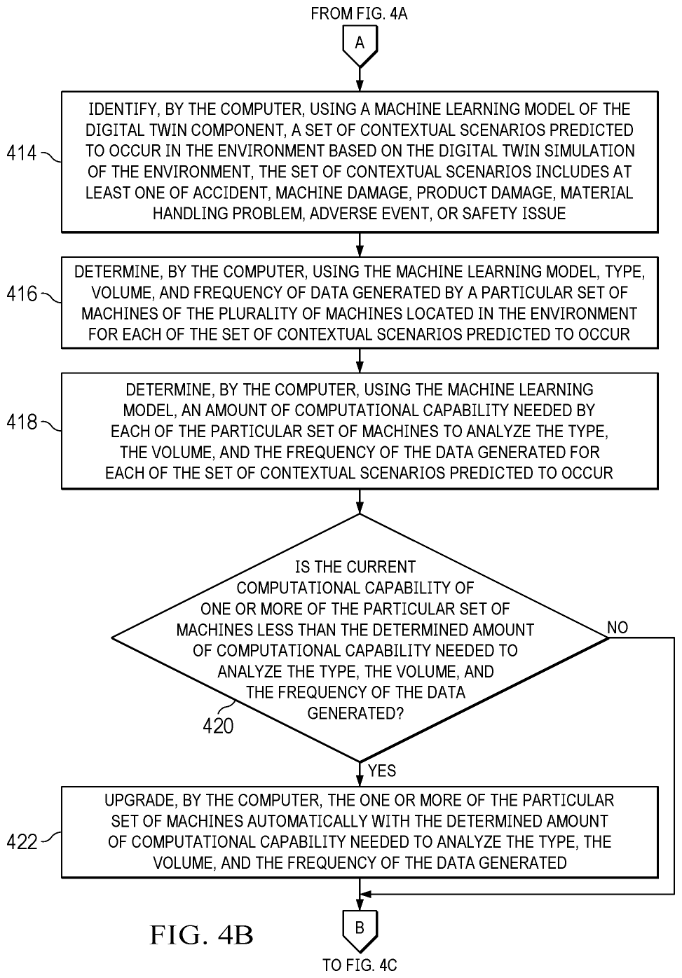

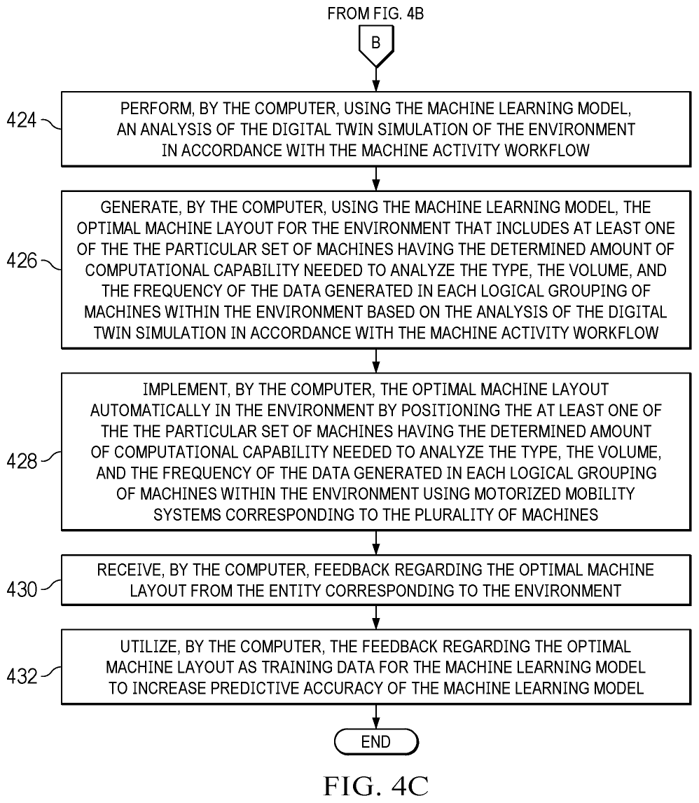

With reference now to FIGS. 4A-4C, a flowchart illustrating a process for managing machine layouts to improve machine activity workflows is shown in accordance with an illustrative embodiment. The process shown in FIGS. 4A-4C may be implemented in a computer, such as, for example, computer 101 in FIG. 1, computer 202 in FIG. 2B, or computer 302 in FIG. 3. For example, the process shown in FIGS. 4A-4C may be implemented in machine layout management code 200 in FIG. 1 or machine layout manager 278 in FIG. 2B.

The process begins when the computer receives an input to generate an optimal machine layout for an environment corresponding to an entity from a client device via a network (step 402). In response to receiving the input, the computer identifies a plurality of machines located in the environment based on a real time feed received from a set of sensors within the environment via the network (step 404). In addition, the computer retrieves specification information for each particular machine of the plurality of machines located in the environment from a database (step 406). The specification information includes, for example, amount of space needed by that particular machine, activity performed by that particular machine, current computational capability of that particular machine, and the like.

The computer monitors the activity performed by each particular machine of the plurality of machines located in the environment using the real time feed received from the set of sensors within the environment (step 408). The computer determines a machine activity workflow corresponding to the plurality of machines that includes identified machine relationships between the plurality of machines, identified relative machine positions of the plurality of machines, and identified different machine activities among the plurality of machines based on monitoring the activity performed by each particular machine of the plurality of machines located in the environment using the real time feed received from the set of sensors within the environment (step 410).

The computer, using a digital twin component of the computer, generates a digital twin simulation of the environment based on the machine activity workflow corresponding to the plurality of machines that includes the identified machine relationships between the plurality of machines, the identified relative machine positions of the plurality of machines, and the identified different machine activities among the plurality of machines (step 412). The computer, using a machine learning model of the digital twin component, identifies a set of contextual scenarios predicted to occur in the environment based on the digital twin simulation of the environment (step 414). The set of contextual scenarios includes at least one of accident, machine damage, product damage, material handling problem, adverse event, or safety issue.

Further, the computer, using the machine learning model, determines type, volume, and frequency of data generated by a particular set of machines of the plurality of machines located in the environment for each of the set of contextual scenarios predicted to occur (step 416). Furthermore, the computer, using the machine learning model, determines an amount of computational capability needed by each of the particular set of machines to analyze the type, the volume, and the frequency of the data generated for each of the set of contextual scenarios predicted to occur (step 418).

Afterward, the computer makes a determination as to whether the current computational capability of one or more of the particular set of machines is less than the determined amount of computational capability needed to analyze the type, the volume, and the frequency of the data generated (step 420). If the computer determines that the current computational capability of one or more of the particular set of machines is greater than or equal to the determined amount of computational capability needed to analyze the type, the volume, and the frequency of the data generated, no output of step 420, then the process proceeds to step 424. If the computer determines that the current computational capability of one or more of the particular set of machines is less than the determined amount of computational capability needed to analyze the type, the volume, and the frequency of the data generated, yes output of step 420, then the computer automatically upgrades the one or more of the particular set of machines with the determined amount of computational capability needed to analyze the type, the volume, and the frequency of the data generated (step 422). The computer automatically upgrades the one or more of the particular set of machines with the determined amount of computational capability needed to analyze the type, the volume, and the frequency of the data generated by at least one of the computer finding and downloading a software upgrade to the one or more of the particular set of machines or the computer instructing a mobile maintenance machine located in the environment to perform a hardware upgrade on the one or more of the particular set of machines.

Moreover, the computer, using the machine learning model, performs an analysis of the digital twin simulation of the environment in accordance with the machine activity workflow (step 424). The computer, using the machine learning model, generates the optimal machine layout for the environment that includes at least one of the particular set of machines having the determined amount of computational capability needed to analyze the type, the volume, and the frequency of the data generated in each logical group of machines within the environment based on the analysis of the digital twin simulation in accordance with the machine activity workflow (step 426).

The computer automatically implements the optimal machine layout in the environment by positioning the at least one of the particular set of machines having the determined amount of computational capability needed to analyze the type, the volume, and the frequency of the data generated in each logical group of machines within the environment using motorized mobility systems corresponding to the plurality of machines (step 428). The computer receives feedback regarding the optimal machine layout from the entity corresponding to the environment via the client device (step 430). The computer utilizes the feedback regarding the optimal machine layout as training data for the machine learning model to increase predictive accuracy of the machine learning model (step 432). Thereafter, the process terminates.

Thus, illustrative embodiments of the present invention provide a computer-implemented method, computer system, and computer program product for intelligently adjusting machine environment layouts to improve machine activity workflow efficiency and safety. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing machine layouts to improve machine activity workflows, the computer-implemented method comprising:
performing, by a computer, using a machine learning model, an analysis of a digital twin simulation of an environment in accordance with a machine activity workflow corresponding to a plurality of machines located in the environment;
generating, by the computer, using the machine learning model, a machine layout for the environment that includes at least one of a particular set of machines having a determined amount of computational capability needed to analyze a type, volume, and frequency of data generated in each logical group of machines within the environment based on the analysis of the digital twin simulation in accordance with the machine activity workflow corresponding to the plurality of machines; and
implementing, by the computer, the machine layout automatically in the environment by positioning the at least one of the particular set of machines having the determined amount of computational capability needed to analyze the type, volume, and frequency of the data generated in each logical group of machines within the environment using mobility systems corresponding to the plurality of machines.

2. The computer-implemented method of claim 1, further comprising:
receiving, by the computer, an input to generate the machine layout for the environment corresponding to an entity from a client device via a network;
identifying, by the computer, the plurality of machines located in the environment based on a real time feed received from a set of sensors within the environment via the network in response to receiving the input; and
retrieving, by the computer, specification information for each particular machine of the plurality of machines located in the environment.

3. The computer-implemented method of claim 2, wherein the specification information for each particular machine includes amount of space needed by that particular machine, activity performed by that particular machine, and current computational capability of that particular machine.

4. The computer-implemented method of claim 2, further comprising:
monitoring, by the computer, an activity performed by each particular machine of the plurality of machines located in the environment using the real time feed received from the set of sensors within the environment; and
determining, by the computer, the machine activity workflow corresponding to the plurality of machines that includes identified machine relationships between the plurality of machines, identified relative machine positions of the plurality of machines, and identified different machine activities among the plurality of machines based on the monitoring of the activity performed by each particular machine of the plurality of machines located in the environment using the real time feed received from the set of sensors within the environment.

5. The computer-implemented method of claim 4, further comprising:
generating, by the computer, using a digital twin component of the computer, the digital twin simulation of the environment based on the machine activity workflow corresponding to the plurality of machines that includes the identified machine relationships between the plurality of machines, the identified relative machine positions of the plurality of machines, and the identified different machine activities among the plurality of machines; and
identifying, by the computer, using the machine learning model of the digital twin component, a set of contextual scenarios predicted to occur in the environment based on the digital twin simulation of the environment.

6. The computer-implemented method of claim 5, wherein the set of contextual scenarios includes at least one of accident, machine damage, product damage, material handling problem, adverse event, or safety issue.

7. The computer-implemented method of claim 5, further comprising:
determining, by the computer, using the machine learning model, the type, volume, and frequency of the data generated by the particular set of machines of the plurality of machines located in the environment for each of the set of contextual scenarios predicted to occur; and
determining, by the computer, using the machine learning model, an amount of computational capability needed by each of the particular set of machines to analyze the type, volume, and frequency of the data generated for each of the set of contextual scenarios predicted to occur.

8. The computer-implemented method of claim 1, further comprising:
determining, by the computer, whether a current computational capability of one or more of the particular set of machines is less than the determined amount of computational capability needed to analyze the type, volume, and frequency of the data generated; and
upgrading, by the computer, the one or more of the particular set of machines automatically with the determined amount of computational capability needed to analyze the type, volume, and frequency of the data generated in response to the computer determining that the current computational capability of one or more of the particular set of machines is less than the determined amount of computational capability needed to analyze the type, volume, and frequency of the data generated.

9. The computer-implemented method of claim 8, wherein the computer automatically upgrades the one or more of the particular set of machines with the determined amount of computational capability needed to analyze the type, volume, and frequency of the data generated by at least one of the computer downloading a software upgrade to the one or more of the particular set of machines or the computer instructing a mobile maintenance machine located in the environment to perform a hardware upgrade on the one or more of the particular set of machines.

10. The computer-implemented method of claim 1, further comprising:
receiving, by the computer, feedback regarding the machine layout from an entity corresponding to the environment via a client device; and
utilizing, by the computer, the feedback regarding the machine layout as training data for the machine learning model to increase predictive accuracy of the machine learning model.

11. A computer system for managing machine layouts to improve machine activity workflows, the computer system comprising:
a communication fabric;
a storage device connected to the communication fabric, wherein the storage device stores program instructions; and
a processor connected to the communication fabric, wherein the processor executes the program instructions to:
perform, using a machine learning model, an analysis of a digital twin simulation of an environment in accordance with a machine activity workflow corresponding to a plurality of machines located in the environment;
generate, using the machine learning model, a machine layout for the environment that includes at least one of a particular set of machines having a determined amount of computational capability needed to analyze a type, volume, and frequency of data generated in each logical group of machines within the environment based on the analysis of the digital twin simulation in accordance with the machine activity workflow corresponding to the plurality of machines; and
implement the machine layout automatically in the environment by positioning the at least one of the particular set of machines having the determined amount of computational capability needed to analyze the type, volume, and frequency of the data generated in each logical group of machines within the environment using mobility systems corresponding to the plurality of machines.

12. The computer system of claim 11, wherein the processor further executes the program instructions to:
receive an input to generate the machine layout for the environment corresponding to an entity from a client device via a network;
identify the plurality of machines located in the environment based on a real time feed received from a set of sensors within the environment via the network in response to receiving the input; and
retrieve specification information for each particular machine of the plurality of machines located in the environment.

13. The computer system of claim 12, wherein the specification information for each particular machine includes amount of space needed by that particular machine, activity performed by that particular machine, and current computational capability of that particular machine.

14. The computer system of claim 12, wherein the processor further executes the program instructions to:
monitor an activity performed by each particular machine of the plurality of machines located in the environment using the real time feed received from the set of sensors within the environment; and
determine the machine activity workflow corresponding to the plurality of machines that includes identified machine relationships between the plurality of machines, identified relative machine positions of the plurality of machines, and identified different machine activities among the plurality of machines based on monitoring the activity performed by each particular machine of the plurality of machines located in the environment using the real time feed received from the set of sensors within the environment.

15. The computer system of claim 14, wherein the processor further executes the program instructions to:
generate, using a digital twin component of the computer system, the digital twin simulation of the environment based on the machine activity workflow corresponding to the plurality of machines that includes the identified machine relationships between the plurality of machines, the identified relative machine positions of the plurality of machines, and the identified different machine activities among the plurality of machines; and
identify, using the machine learning model of the digital twin component, a set of contextual scenarios predicted to occur in the environment based on the digital twin simulation of the environment.

16. A computer program product for managing machine layouts to improve machine activity workflows, the computer program product comprising a computer-readable storage medium having program instructions embodied therewith, the program instructions executable by a computer to cause the computer to perform a method of:
performing, by the computer, using a machine learning model, an analysis of a digital twin simulation of an environment in accordance with a machine activity workflow corresponding to a plurality of machines located in the environment;
generating, by the computer, using the machine learning model, a machine layout for the environment that includes at least one of a particular set of machines having a determined amount of computational capability needed to analyze a type, volume, and frequency of data generated in each logical group of machines within the environment based on the analysis of the digital twin simulation in accordance with the machine activity workflow corresponding to the plurality of machines; and
implementing, by the computer, the machine layout automatically in the environment by positioning the at least one of the particular set of machines having the determined amount of computational capability needed to analyze the type, volume, and frequency of the data generated in each logical group of machines within the environment using mobility systems corresponding to the plurality of machines.

17. The computer program product of claim 16, further comprising:
receiving, by the computer, an input to generate the machine layout for the environment corresponding to an entity from a client device via a network;
identifying, by the computer, the plurality of machines located in the environment based on a real time feed received from a set of sensors within the environment via the network in response to receiving the input; and
retrieving, by the computer, specification information for each particular machine of the plurality of machines located in the environment.

18. The computer program product of claim 17, wherein the specification information for each particular machine includes amount of space needed by that particular machine, activity performed by that particular machine, and current computational capability of that particular machine.

19. The computer program product of claim 17, further comprising:
monitoring, by the computer, an activity performed by each particular machine of the plurality of machines located in the environment using the real time feed received from the set of sensors within the environment; and
determining, by the computer, the machine activity workflow corresponding to the plurality of machines that includes identified machine relationships between the plurality of machines, identified relative machine positions of the plurality of machines, and identified different machine activities among the plurality of machines based on the monitoring of the activity performed by each particular machine of the plurality of machines located in the environment using the real time feed received from the set of sensors within the environment.

20. The computer program product of claim 19, further comprising:
generating, by the computer, using a digital twin component of the computer, the digital twin simulation of the environment based on the machine activity workflow corresponding to the plurality of machines that includes the identified machine relationships between the plurality of machines, the identified relative machine positions of the plurality of machines, and the identified different machine activities among the plurality of machines; and
identifying, by the computer, using the machine learning model of the digital twin component, a set of contextual scenarios predicted to occur in the environment based on the digital twin simulation of the environment.
